(19) United States
(12) Patent Application Publication
(10) Pub. No.: US 2016/0048314 A1
(43) Pub. Date: Feb. 18, 2016

(54) DISPLAY APPARATUS AND METHOD OF CONTROLLING THE SAME

(71) Applicant: SAMSUNG ELECTRONICS CO., LTD., Suwon-si (KR)

(72) Inventor: Ji-youn HAN, Seoul (KR)

(73) Assignee: SAMSUNG ELECTRONICS CO., LTD., Suwon-si (KR)

(21) Appl. No.: 14/736,837

(22) Filed: Jun. 11, 2015

(30) Foreign Application Priority Data
Aug. 14, 2014 (KR) 10-2014-0105806

(51) Int. Cl. G06F 3/0484

(52) U.S. Cl. CPC G06F 3/04847; G06F 3/04842

(57) ABSTRACT

A display apparatus and a method of controlling the same are provided. The display apparatus includes: a display configured to display content on a screen; a user interface configured to receive a user command; and a processor configured to control the display to display a keyword associated with the displayed content and to update, in response to the displayed content being changed according to the received user command, the displayed keyword to an updated keyword associated with changed content.

### CROSS-REFERENCE TO RELATED APPLICATION

This application claims priority from Korean Patent Application No. 10-2014-0105806, filed on Aug. 14, 2014 in the Korean Intellectual Property Office, the disclosure of which is incorporated herein by reference in its entirety.

### BACKGROUND

1. Field

Apparatuses and methods consistent with exemplary embodiments relate to a display apparatus and a method of controlling the same, and more particularly, to a display apparatus that is capable of providing multi-screens and a method of controlling the same.

2. Description of Related Art

Due to the increase in the development of electronic technologies, various types of display apparatuses have been developed. For example, display apparatuses such as a television (TV), a personal computer (PC), a laptop computer, a tablet personal computer (PC), a cellular phone, an MP3 player, and the like, have a high rate of being used in most homes.

In order to meet a user demand for new and various functions, there have been efforts to develop a newer type of display apparatus. For example, a smart TV function provides a multi-screen function that includes simultaneously viewing TV broadcasting and the Internet.

However, there is a need for a method of more effectively using the multi-screen function.

### SUMMARY

One or more exemplary embodiments overcome the above disadvantages and other disadvantages not described above. Also, an exemplary embodiment is not required to overcome the disadvantages that are described above, and an exemplary embodiment may not overcome any of the problems described above.

Aspects of one or more exemplary embodiments provide a display apparatus and a method of controlling the same, for effectively providing information associated with currently watched content in a multi-screen mode.

According to an aspect of an exemplary embodiment, there is provided a display apparatus including: a display configured to display content on a screen; a user interface configured to receive a user command; and a processor configured to control the display to display a keyword associated with the displayed content and to update, in response to the displayed content being changed according to the received user command, the displayed keyword to an updated keyword associated with changed content.

The processor may be further configured to control the display to display associated content information obtained according to the displayed keyword.

The processor may be further configured to, when a content refresh function is off, control the display to maintain the displayed associated content information and to update the displayed keyword to the updated keyword associated with the changed content; and the processor may be further configured to, when the content refresh function is on, control the display to update the displayed keyword to the updated keyword associated with the changed content and to update the displayed associated content information to updated associated content information obtained according to the updated keyword.

The processor may be further configured to control the display to display a graphic user interface (GUI) for selection of an on/off state of the content refresh function.

The processor may be further configured to control the display to display the associated content information obtained according to the displayed keyword in a preset content search domain selected according to a preset event.

The content search domain may be selected from among at least one of a video content domain, a web browser domain, and an application domain.

The processor may be further configured to control the display to display the content on a screen from among multi-screens simultaneously presented on the display, and to display the associated keyword and the associated content information on at least one other screen among the multi-screens.

The processor may be further configured to control the display to simultaneously present multi-screens on the display; the processor may be further configured to control the display to display a selection GUI for selection of one of the multi-screens; and the processor may be further configured to control the display to enlarge a screen, among the multi-screens, focused by the selection GUI and to relatively reduce and display one or more remaining screens, among the multi-screens, when the selection GUI is focused on the screen according to a user command.

The processor may be further configured to control the display to focus at least one item contained in the multi-screens by the selection GUI according to the received user command, to enlarge the screen to which the at least one item focused by the selection GUI belongs, and to relatively reduce and display the one or more remaining screens.

In response to the at least one item focused by the selection GUI being selected, the processor may be further configured to control the display to display a content executing image corresponding to the selected item while maintaining an enlarged screen size.

According to an aspect of another exemplary embodiment, there is provided a method of controlling a display apparatus, the method including: displaying content and a keyword associated with the content according to a preset event; and in response to the displayed content being changed according to a user command, updating the displayed keyword to an updated keyword associated with the changed content.

The displaying the keyword may include displaying associated content information obtained according to the displayed keyword.

The updating may include: when a content refresh function is off, maintaining the displayed associated content information and updating the displayed keyword to the updated keyword associated with the changed content; and when the content refresh function is on, updating the displayed keyword to the updated keyword associated with the changed content and updating the displayed associated content information to updated associated content information obtained according to the updated keyword.

The method may further include displaying a graphic user interface (GUI) for selection of an on/off state of the content refresh function.

The displaying the keyword may include displaying associated content information obtained according to the displayed keyword in a preset content search domain selected according to a preset event.

The content search domain may be selected from among at least one of a video content domain, a web browser domain, and an application domain.

The displaying the keyword may include displaying the content on a screen from among multi-screens simultaneously displayed, and displaying the associated keyword and the associated content information on at least one other screen of the multi-screens.

The method may further include: simultaneously displaying multi-screens; displaying a selection GUI for selection of one of the multi-screens; and enlarging a screen, among the multi-screens, focused by the selection GUI and relatively reducing and displaying one or more remaining screens, among the multi-screens, when the selection GUI is focused on the screen according to a user command.

The enlarging the screen may include focusing at least one item contained in the multi-screens by the selection GUI according to the user command, enlarging the screen to which the at least one item focused by the selection GUI belongs, and relatively reducing and displaying the one or more remaining screens.

The method may further include, in response to the at least one item focused by the selection GUI being selected, displaying a content executing image corresponding to the at least one item while maintaining an enlarged screen size.

According to an aspect of another exemplary embodiment, there is provided an image processing apparatus including: a processor configured to control to: output, for display, content; output, for display, a keyword associated with the output content; and update, in response to the output content being changed, the output keyword to an updated keyword associated with changed content.

The processor may be further configured to control to output, for display, associated content information obtained according to the output keyword.

The processor may be further configured to control to output, for display, the content on a screen from among multi-screens simultaneously output, and to output, for display, the associated keyword and the associated content information on at least one other screen among the multi-screens.

The processor may be further configured to control to: simultaneously output, for display, multi-screens; output, for display, a selection GUI for selection of one of the multi-screens; and enlarge a screen, among the multi-screens, focused by the selection GUI and to relatively reduce and display one or more remaining screens, among the multi-screens, when the selection GUI is focused on the screen according to a user command.

The processor may be further configured to control to focus at least one item contained in the multi-screens by the selection GUI according to a user command, to enlarge the screen to which the at least one item focused by the selection GUI belongs, and to relatively reduce and output, for display, the one or more remaining screens.

According to an aspect of another exemplary embodiment, there is provided a non-transitory computer readable recording medium having recorded thereon a program executable by a computer for performing the above method.

Accordingly, content information of content that is currently watched by a user may be effectively provided, thereby improving user convenience. In addition, a screen in which a user is highly interested may be automatically enlarged in size and provided in a multi-screen mode, thereby improving user convenience.

Additional and/or other aspects and advantages will be set forth in part in the description which follows and, in part, will be obvious from the description, or may be learned by practice of one or more exemplary embodiments.

### BRIEF DESCRIPTION OF THE DRAWINGS

The above and/or other aspects will become more apparent by describing certain exemplary embodiments with reference to the accompanying drawings, in which:

FIG. 1 is a diagram illustrating a display system according to an exemplary embodiment;

FIG. 2A is a block diagram illustrating an example of a display apparatus according to an exemplary embodiment;

FIG. 2B is a block diagram illustrating an example of the display apparatus illustrated in FIG. 2A according to an exemplary embodiment;

FIG. 3 is a diagram illustrating various software modules that are stored in a storage device according to an exemplary embodiment;

FIGS. 4A and 4B are diagrams illustrating a method for providing a multi-screen mode according to one or more exemplary embodiments;

FIGS. 5A and 5B are diagrams illustrating a method for changing a search domain according to an exemplary embodiment;

FIGS. 6A to 6C are diagrams illustrating examples in which the search domain is changed in FIG. 5B according to one or more exemplary embodiments;

FIGS. 7A and 7B are diagrams illustrating a content refresh function according to an exemplary embodiment;

FIGS. 8A and 8B are diagrams illustrating a method for providing a multi-screen mode according to another exemplary embodiment;

FIGS. 9A to 9C are diagrams illustrating a method of adjusting a screen size in a multi-screen mode according to another exemplary embodiment;

FIG. 10 is a flowchart illustrating a method of controlling a display apparatus according to an exemplary embodiment;

FIG. 11 is a flowchart illustrating a method of controlling a display apparatus according to another exemplary embodiment; and

FIG. 12 is a flowchart illustrating a method of controlling a display apparatus according to another exemplary embodiment.

### DETAILED DESCRIPTION

Exemplary embodiments will now be described in greater detail with reference to the accompanying drawings. In this regard, exemplary embodiments may have different forms and should not be construed as being limited to the descriptions set forth herein. Accordingly, exemplary embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

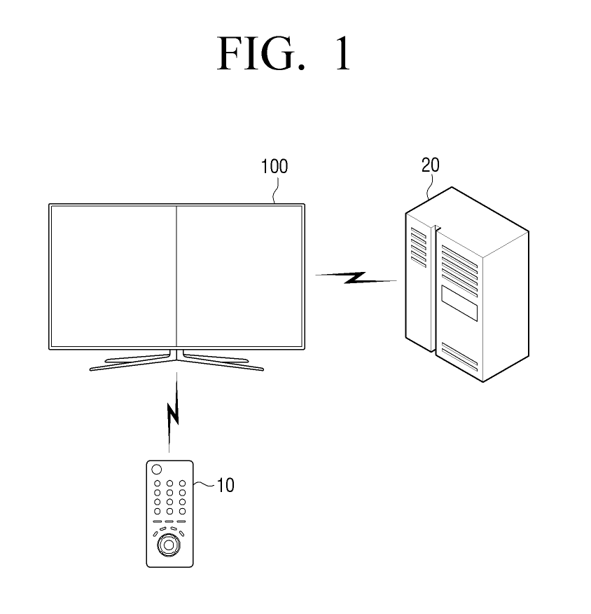

FIG. 1 is a diagram for explanation of a display system according to an exemplary embodiment.

Referring to FIG. 1, the display system includes a display apparatus 100 and a server 20.

The display apparatus 100 may be embodied as a digital television (TV), but is not limited thereto. The display apparatus 100 may be embodied as various types of apparatuses with a display function, such as a smart phone, a tablet personal computer (PC), a portable multimedia player (PMP), a personal digital assistant (PDA), a navigation device, a digital camera, a monitor, a laptop computer, etc.

When the display apparatus 100 is embodied as a digital TV, the display apparatus 100 may be controlled by a remote control apparatus 10, a user motion, or a user voice. For example, the remote control apparatus 10 may be embodied in various forms, and may transmit a signal corresponding to an input key, may detect movement and transmit a signal corresponding to the movement, and/or may recognize a voice and transmit a signal corresponding to the voice. In this case, the remote control apparatus 10 may be embodied to include at least one of a motion sensor, a touch sensor, an optical joystick (OJ) sensor that applies optical technology, a physical button (e.g., a tact switch), a display screen, a microphone, etc., in order to receive various types of user commands according to a type of the remote control apparatus 10.

The display apparatus 100 according to an exemplary embodiment may be embodied to provide multi-screens (i.e., multiple screens at the same time) so as to simultaneously provide or perform various tasks and to provide various types of associated contents about currently watched content through the multi-screens. For example, the display apparatus 100 may simultaneously provide, through the multi-screens, currently watched broadcasting content and web-based content, received through the server 20, associated with the corresponding broadcasting content.

Hereinafter, various exemplary embodiments will be described with reference to a block diagram illustrating a detailed configuration of the display apparatus 100.

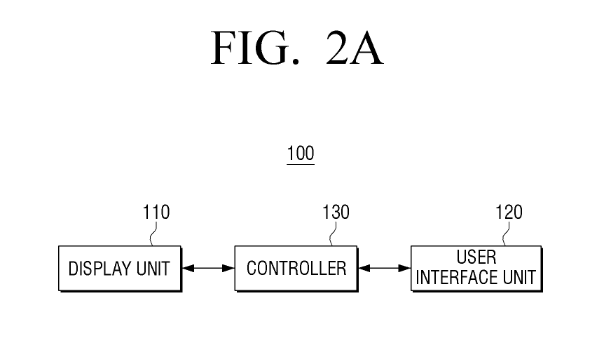

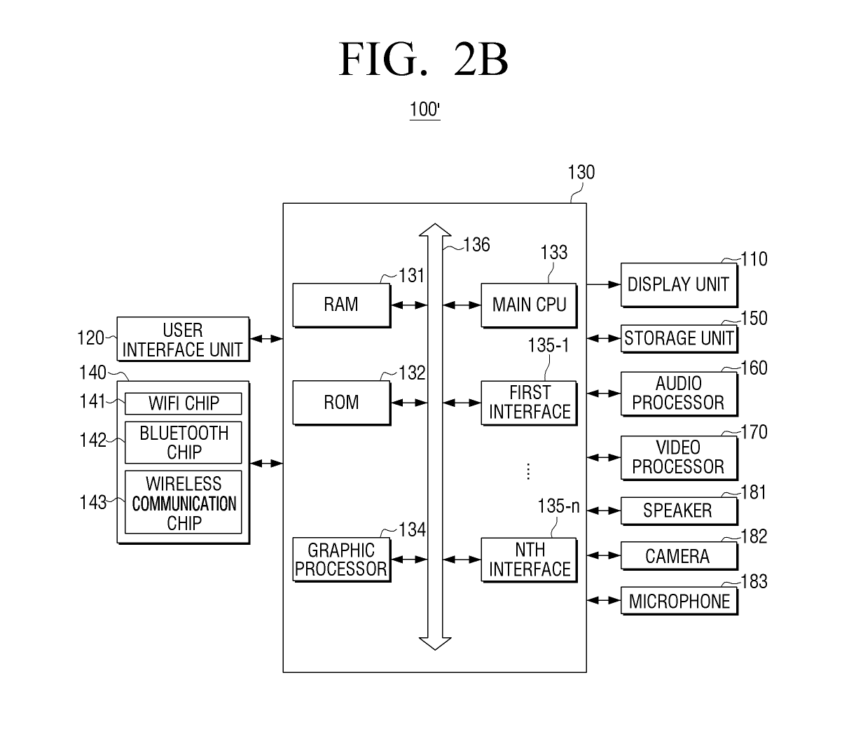

FIG. 2A is a block diagram illustrating a configuration of the display apparatus 100 according to an exemplary embodiment.

Referring to FIG. 2A, the display apparatus 100 includes a display 110 (e.g., display unit), a user interface unit 120 (e.g., user interface device or user interface), and a processor 130 (e.g., control unit).

The display 110 displays an image. Here, the image may include various contents such as an image, a video, a text, a music, etc., an application executing image including various contents, a graphic user interface (GUI) image, etc.

In particular, the display 110 may provide a multi-screens mode under control of the processor 130 in response to a preset event occurring.

The display 110 may be, but is not limited to, a liquid crystal display (LCD) panel, an organic light emitting diode (OLED) display, a plasma display, an active matrix OLED (AMOLED) display, or the like.

The user interface unit 120 receives various user commands.

In particular, the user interface unit 120 may receive various user commands such as a command for selection of one of multi-screens, a command for selection of an item provided by a screen, an ON/OFF command for a content refresh function to be described below, a keyword selection command, and so on.

The user interface unit 120 may be embodied in various forms according to a type of the display apparatus 100. For example, when the display apparatus 100 is embodied as a digital TV, the user interface unit 120 may be embodied as, but is not limited to, a REMOCON receiver for receiving a REMOCON signal from the remote control apparatus 10, a camera for receiving a user motion, a microphone for receiving a user voice, a key included in a panel, and so on.

The processor 130 controls an overall operation of the display apparatus 100.

For example, the processor 130 may control the display 110 to display a keyword associated with displayed content on one region of a screen.

In detail, the processor 130 may provide a keyword based on various information items such as a title, characters, a place, character, an item, sound, and so on that are contained in metadata that is received together with displayed content. However, it is understood that one or more other exemplary embodiments are not limited thereto. For example, the processor 130 may provide a keyword associated with corresponding content via web search or provide a keyword by a server associated with corresponding content by default. In addition, depending on the cases, the processor 130 may provide a popular search word together with a keyword in a current search site even if the popular search word is not associated with corresponding content.

In response to displayed content being changed according to a user command received through the user interface unit 120, the processor 130 may control the display 110 to update a displayed keyword to a keyword associated with the changed content.

In addition, the processor 130 may control the display 110 to display associated content information retrieved according to the displayed keyword. For example, in response to a keyword such as “Paris”, “Woody Allen”, and “midnight in Paris”, which are associated with the displayed content, being provided, the processor 130 may control the display 110 to display associated content information received through “Paris” as a first keyword. Here, the associated content information may be provided in various types such as a thumbnail image, a text, an icon, and so on, which include a still image or a video.

In this case, the processor 130 may provide associated content information retrieved according to an associated keyword in a preset content search domain selected according to a preset event. Here, a content search domain for a content search may include at least one of a video content domain, a web browser domain, and an application domain. For example, the processor 130 may provide web page information retrieved through a keyword “Paris” in the web browser domain provided by default upon entering a corresponding service. In addition, the processor 130 may provide video content information retrieved through the keyword “Paris” in the video content domain selected according to a user command.

In response to displayed content being changed, the processor 130 may update a displayed keyword to a keyword associated with the changed content and may also update and provide content information retrieved according to the updated keyword.

In detail, when a content refresh function is off, the processor 130 may maintain displayed associated content information, update only the displayed keyword to the keyword associated with the changed content, and provide the updated keyword. In addition, when the content refresh function is on, the processor 130 may update the displayed keyword to the keyword associated with the changed content and may also or simultaneously update the displayed associated content information to the associated content information retrieved according to the updated keyword and provide the updated associated content information.

In this case, the processor 130 may display a GUI or menu for turning the content refresh function on or off. For example, a GUI may be displayed on a screen so as to set an on/off state of the content refresh function through selection of the corresponding GUI or an on/off state of a corresponding function may be set through a separate setting menu.

The processor 130 may provide the aforementioned service through a multi-screen mode. In detail, the processor 130 may control the display 110 to display content on one of multi-screens and to display an associated keyword and associated content information on another one of the multi-screen. In this case, the processor 130 may provide the associated keyword and the associated content information through one screen according to a domain type for providing associated content or provide the associated keyword and the associated content information through two screens or more. For example, in the case of a web browser domain, the associated keyword and the associated content information may be provided through one screen, and in the case of a video content domain, the associated keyword and the associated content information may be provided through two screens. In this case, one of the two screens may provide video content retrieved according to the associated keyword and a first keyword and the other of the two screens may provide an image for reproducing selected video content.

The processor 130 may control the display 110 to display a selection GUI for selection of one of multi-screens and to output audio corresponding to a screen selected by the selection GUI. Here, the selection GUI may be embodied in various types of a cursor GUI, a focusing GUI, a highlight GUI, and so on.

In response to a screen focused by the selection GUI being changed, the processor 130 may control the display 110 to enlarge and display a screen region focused by the selection GUI and to relatively reduce and display the remaining screen region. It is understood that the present exemplary embodiment may be applied to a multi-screen mode in which an associated keyword and content are not provided according to one or more other exemplary embodiments.

The processor 130 may control the display 110 to focus at least one item contained in the multi-screens by the selection GUI according to a user command, to enlarge and display a screen region in which the item is focused by the selection GUI, and to relatively reduce and display the remaining screen region.

In response to the item selected by the selection GUI being selected, the processor 130 may provide a content executing image corresponding to the item while maintaining the enlarged screen size.

When the selection GUI is restored to a position prior to adjustment of a screen size according to a user command, the processor 130 may also restore the screen size to a previous size.

In addition, the processor 130 may adjust an arrangement state of the multi-screens. For example, when a multi-screen mode of including first to third screens is provided, the arrangement state may be adjusted. In this case, by way of example, positions of the first and second screens may be changed according to a user command or a preset event.

FIG. 2B is a block diagram illustrating a detailed configuration of a display apparatus 100′ according to an exemplary embodiment. Referring to FIG. 2B, the display apparatus 100′ includes the display 110, the user interface unit 120, the processor 130, a communication unit 140 (e.g., communicator), a storage unit 150 (e.g., storage), an audio processor 160, a video processor 170, a speaker 181, a camera 182, and a microphone 183. Redundancies between components illustrated in FIG. 2B and components illustrated in FIG. 2A are omitted below.

The communication unit 140 communicates with external devices according to various types of communication methods.

In particular, the communication unit 140 may communicate with the remote control apparatus 10 (refer to FIG. 1) for control of the display apparatus 100′ and communicate with the server 20 (refer to FIG. 1) for providing various network-based services, for example, a web server for providing web video content, a web page, a web-based application, and so on.

In this case, the communication unit 140 may communicate with an external input device or an external server through various wired and wireless communication methods such as a radio frequency (RF) communication, for example, Bluetooth (BT), wireless fidelity (WI-FI), Zigbee, infrared (IR), a serial interface, a universal serial bus (USB), and so on.

In detail, in response to a preset event occurring, the communication unit 140 may communicate with an external input device or an external server according to a communication method so as to be associated therewith. Here , the association may refer to any state including an operation for initializing communication between the display apparatus 100 and the external input device or the external server, an operation for formation of a network, an operation for device pairing, and so on.

The processor 130 controls an overall operation of the display apparatus 100′ using various programs stored in the storage unit 150.

In detail, the processor 130 includes a random-access memory (RAM) 131, a read-only memory (ROM) 132, a main central processing unit (CPU) 133, a graphic processor 134, first to n^{th} interfaces 135-1 to 135-n, and a bus 136.

The RAM 131, the ROM 132, the main CPU 133, the graphic processor 134, the first to n^{th} interfaces 135-1 to 135-n, and so on may be connected to each other through the bus 136.

The first to n^{th} interfaces 135-1 to 135-n are connected to the aforementioned various components. One of interfaces may be a network interface that is connected to an external device through a network.

The main CPU 133 may access the storage unit 150 and perform booting using an operating system (O/S) stored in the storage unit 150. In addition, the main CPU 133 may perform various operations using various programs, content, data, and so on stored in the storage unit 150. In particular, the main CPU 133 may process a plurality of data items displayed on multi-screens for each screen according to an exemplary embodiment.

The ROM 132 stores a command set, and so on for system booting. When a turn-on command is input to supply power, the main CPU 133 copies the O/S (or a portion thereof) stored in the storage unit 150 according to a command stored in the ROM 132 to the RAM 131 and executes the O/S to boot the system. When booting is completed, the main CPU 133 copies various application programs stored in the storage unit 150 to the RAM 131 and executes the application program copied to the RAM 131 to perform various operations.

The graphic processor 134 generates an image containing various objects such as an icon, an image, a text, and so on using a calculator and a renderer. The calculator calculates an attribute value such as a coordinate value, a shape, a size, a color, and so on for displaying objects according to a layout of an image based on a received control command. The renderer generates various layouts of images based on the attribute value calculated by the calculator. The image generated by the renderer is displayed in a display region of the display 110.

The storage unit 150 stores various data items such as an O/S software module for driving the display apparatus 100′, various multimedia contents, various applications, various contents that are input or set during execution of an application, and so on.

In particular, the storage unit 150 may store various information items such as a size distribution state, a screen size, screen edit information provided according to a distribution state and size adjustment, etc., which are provided in a multi-screen mode.

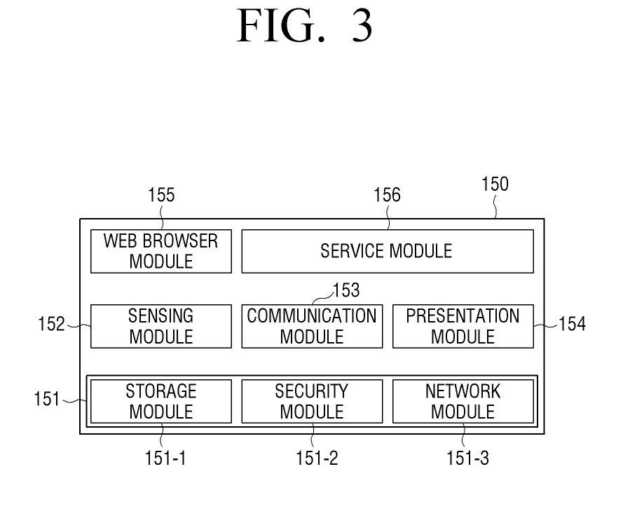

In addition, various software modules stored in the storage unit 150 will be described with reference to FIG. 3.

Referring to FIG. 3, the storage unit 150 may store software including a base module 151, a sensing module 152, a communication module 153, a presentation module 154, a web browser module 155, and a service module 156.

The base module 151 refers to a basic module for processing a signal transmitted from respective hardware included in the display apparatus 100′ and transmitting the processed signal to a higher layer module. The base module 151 includes a storage module 151-1, a security module 151-2, a network module 151-3, and so on. The storage module 151-1 refers to a program module for managing a database (DB) or a register. The main CPU 133 may access a database in the storage unit 150 using the storage module 151-1 to extract various data items. The security module 151-2 refers to a program module for supporting certification for hardware, requesting permission, security storage, and so on, and the network module 151-3 includes a DNET module, a Universal Plug and Play (UPnP) module, and so on for supporting network access.

The sensing module 152 is a module that collects information from various sensors and analyzes and manages the collected information. The sensing module 152 may include a head direction recognition module, a face recognition module, a voice recognition module, a motion recognition module, a Near Field Communication (NFC) recognition module, and so on.

The communication module 153 is a module for external communication. The communication module 153 may include a device module used to communicate with an external device, a messaging module such as a messenger program, a short message service (SMS) and multimedia message service (MMS) program, and an e-mail program, and a telephone module including a call info aggregator program module and a Voice over IP (VoIP) module.

The presentation module 154 is a module for configuration of a display image. The presentation module 154 includes a multimedia module for reproducing and outputting multimedia content and a UI rendering module for performing UI and graphic processing.

The web browser module 155 refers to a module that performs web browsing to access a web server. The web browser module 155 may include various modules such as a web view module for configuration of a web page, a download agent module for performing download, a bookmark module, a Webkit module, and so on.

The service module 156 is a module including various applications for providing various services. In detail, the service module 156 may include various program modules such as a social networking service (SNS) program, a content reproduction program, a game program, an e-book program, a calendar program, an alarm management program, other Widgets, and so on.

In addition, the display apparatus 100′ may further include the audio processor 160 for processing audio data, the video processor 170 for processing video data, the speaker 181 for outputting various alarm sounds or voice messages as well as various audio data items processed by the audio processor 160, the camera 182 for capturing a still image or a video according to user control, and the microphone 183 for receiving a user voice or other sounds and converting the received user voice or other sounds to audio data.

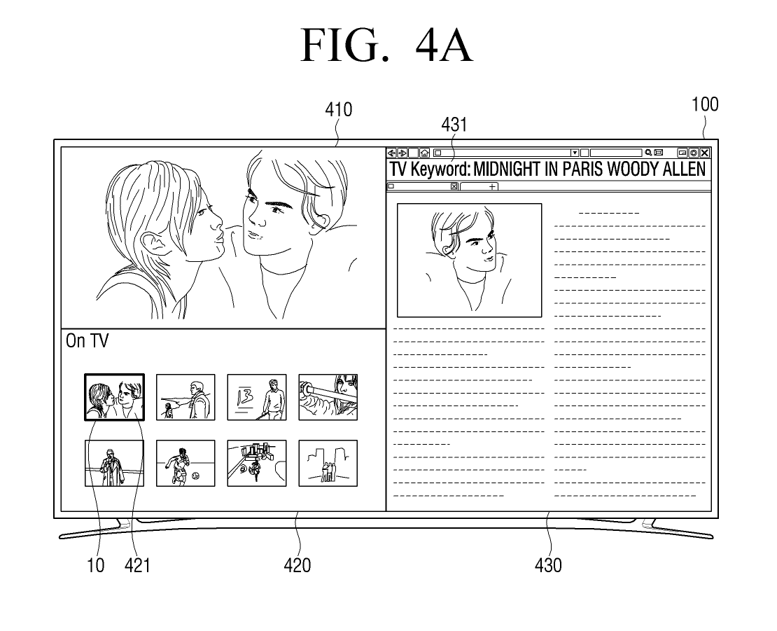

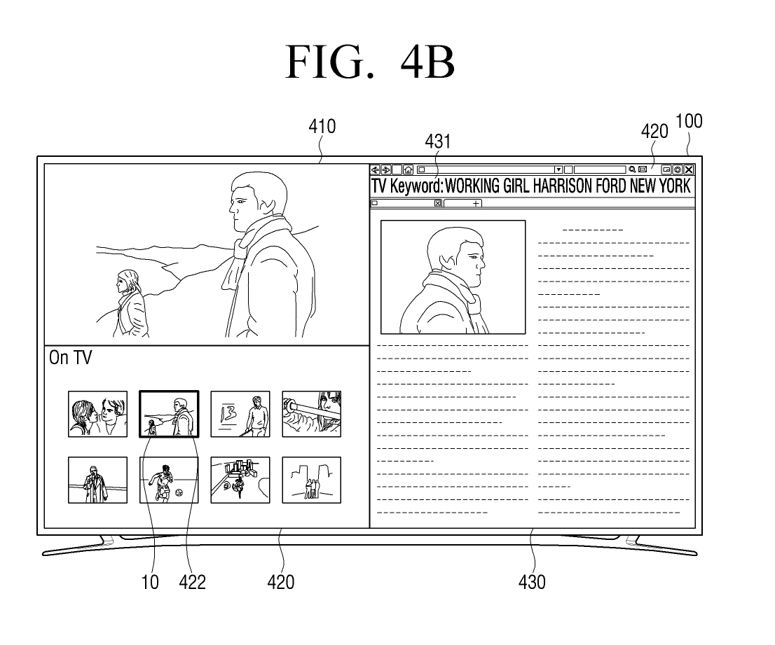

FIGS. 4A and 4B are diagrams illustrating a method for providing a multi-screen mode according to one or more exemplary embodiments.

Referring to FIG. 4A, according to a preset event, for example, a user command for entrance into a corresponding mode, a current mode may enter a multi-screen mode for providing associated information about currently watched content.

When the current mode enters the multi-screen mode, currently watched content may be displayed on a first screen 410 of multi-screens of a display apparatus 100 and content information to be provided by the display apparatus 100 in addition to the corresponding content may be displayed on a second screen 420 of the multi-screens. For example, a UI image may include real time broadcasting content information on the second screen 420 of the multi-screens. In this case, the content information may be provided in the form of a thumbnail image, and a selection GUI 10 may be positioned in the thumbnail image indicating currently watched content 421. Here, the thumbnail image may be provided in various forms such as a still image, a video, a slideshow, etc.

A third screen 430 of the multi-screens may provide content information associated with currently watched content. In this case, the associated content information may be provided based on a preset content search domain. For example, a search domain provided in an initial image during entrance of the multi-screen mode may be determined to be a web browser domain by default but may be changed according to user description, settings, or input.

In detail, the third screen 430 may provide keyword information 431 associated with the currently watched content provided in the first screen 410 and a web content search result retrieved according to at least one of the keyword information 431. Here, a keyword used for a search may be, but is not limited to, a first displayed keyword. In addition, the keyword information 431 may be provided in an uppermost end of a web browser region, although it is understood that one or more other exemplary embodiments are not limited thereto.

As shown in FIG. 4B, in response to currently watched content being changed according to movement of the selection GUI 10 positioned in the second screen 420, that is, in response to changed content being displayed on the first screen 410, the keyword information 431 displayed on the third screen 430 may be updated to keyword information 432 corresponding to the changed content. In this case, the search result according to a keyword, provided by the third screen 430, may be updated according to settings or may not be updated, which will be described below.

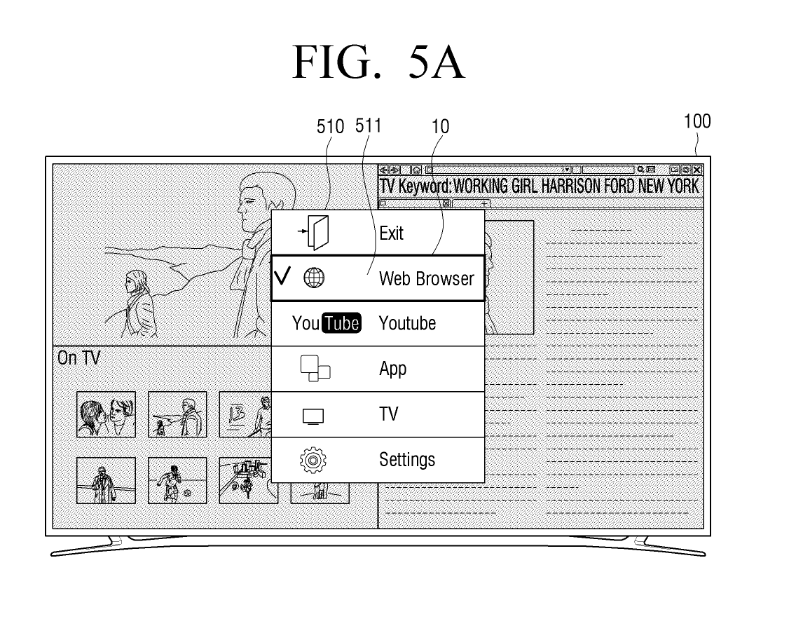

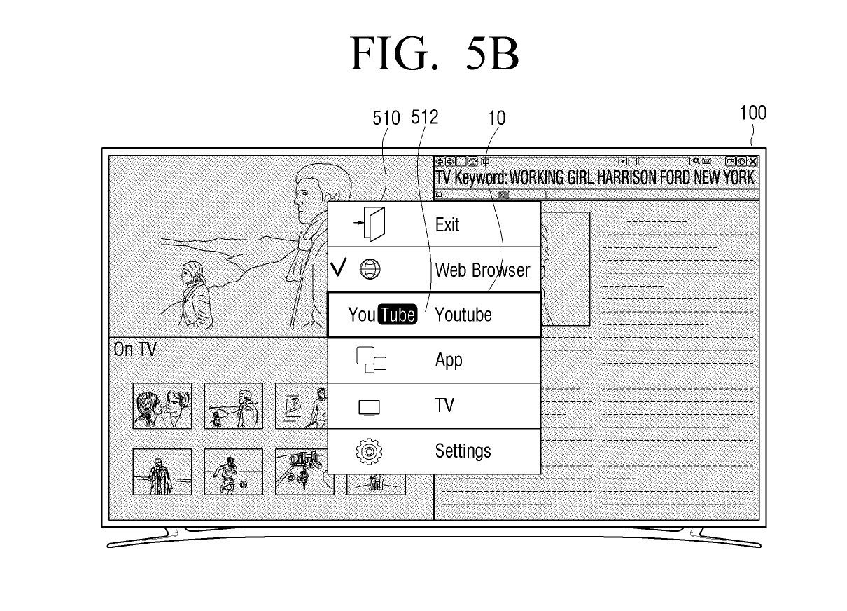

FIGS. 5A and 5B are diagrams illustrating a method for changing a search domain according to one or more exemplary embodiments.

As shown in FIG. 5A, a UI menu 510 for changing a search domain for providing associated content may be provided according to a preset event. In this case, the selection GUI 10 may be provided in a menu item 511 corresponding to a currently provided search domain, for example, an item “Web Browser” 511 as a currently provided search domain in the embodiment shown in FIG. 4B.

As shown in FIG. 5B, the selection GUI 10 may be moved on the UI menu 510 to change a search domain for providing associated content. FIG. 5B illustrates a state in which the selection GUI 10 is moved to an item “Youtube” 512 from the selection GUI 10 according to a user command.

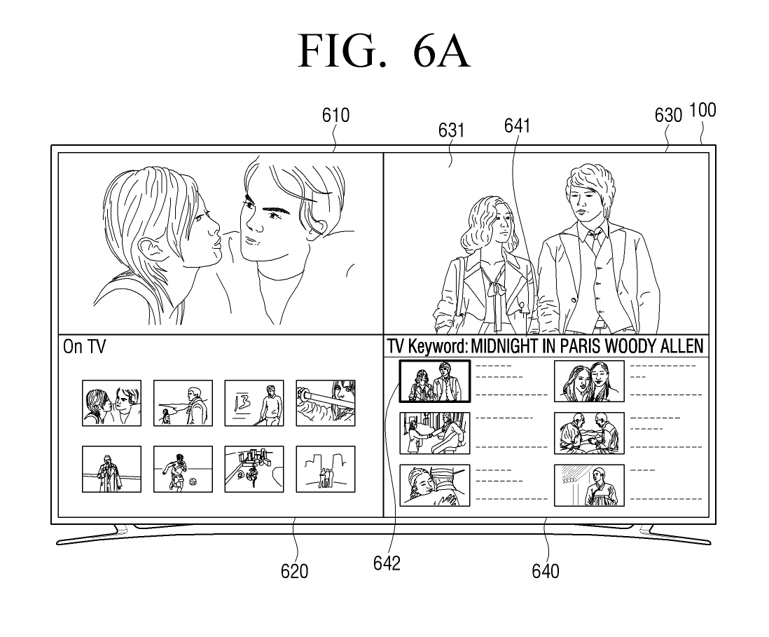

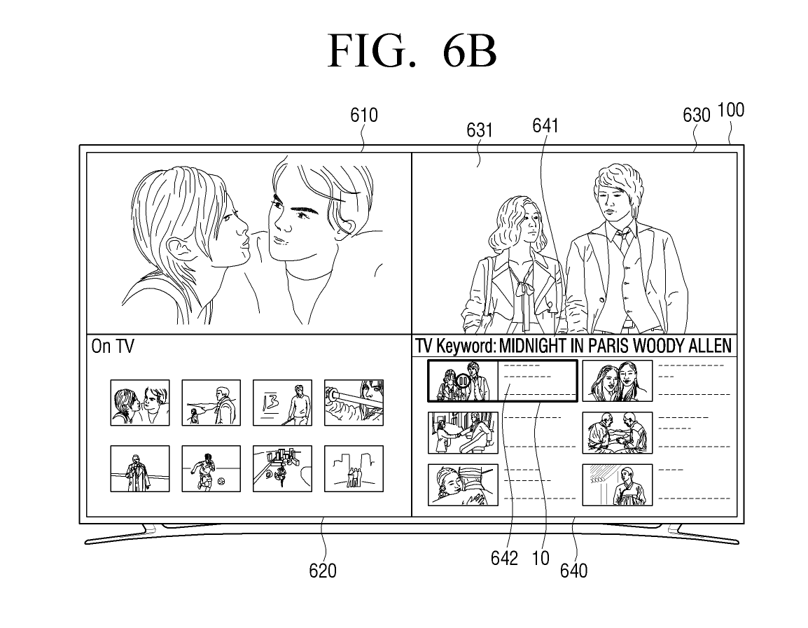

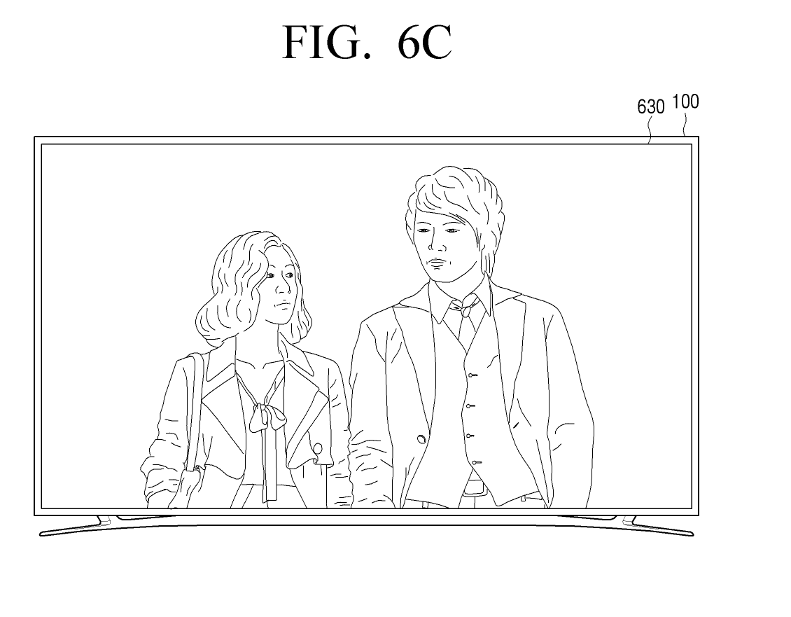

FIGS. 6A to 6C are diagrams illustrating examples in which the search domain is changed in FIG. 5B according to one or more exemplary embodiments.

As shown in FIG. 5B, when the search domain is changed to a video content domain (e.g., Youtube) from a web browser search domain, a UI image corresponding to a corresponding search domain may be provided in third screens 630 and 640, as shown in FIG. 6A. In detail, keyword information 641 associated with currently watched content and a video search result 642 retrieved according to at least one of the keyword information 641 may be provided in a screen 640 (e.g., second sub-screen) among the third screens 630 and 640. For example, a keyword as a search object may be a first keyword of displayed keywords.

In addition, one of retrieved video contents, for example, information about first displayed video content, may be provided in a screen 630 (e.g., first sub-screen) of the third screens 630 and 640. Here, information may be provided in the form of a thumbnail image including a still image, a video, or a slideshow, or in the form of reproduction of corresponding video content.

As shown in FIG. 6B, in response to one 641-1 of retrieved video contents being selected by the selection GUI 10, the selected video content may be produced on an entire screen, as shown in FIG. 6C. However, according to another exemplary embodiment, when the selected video content 641-1 is reproduced on the first sub-screen 630 of the third screens 630 and 640, if there is an additional user command, for example, an entire screen viewing command, the selected video content may be reproduced on an entire screen.

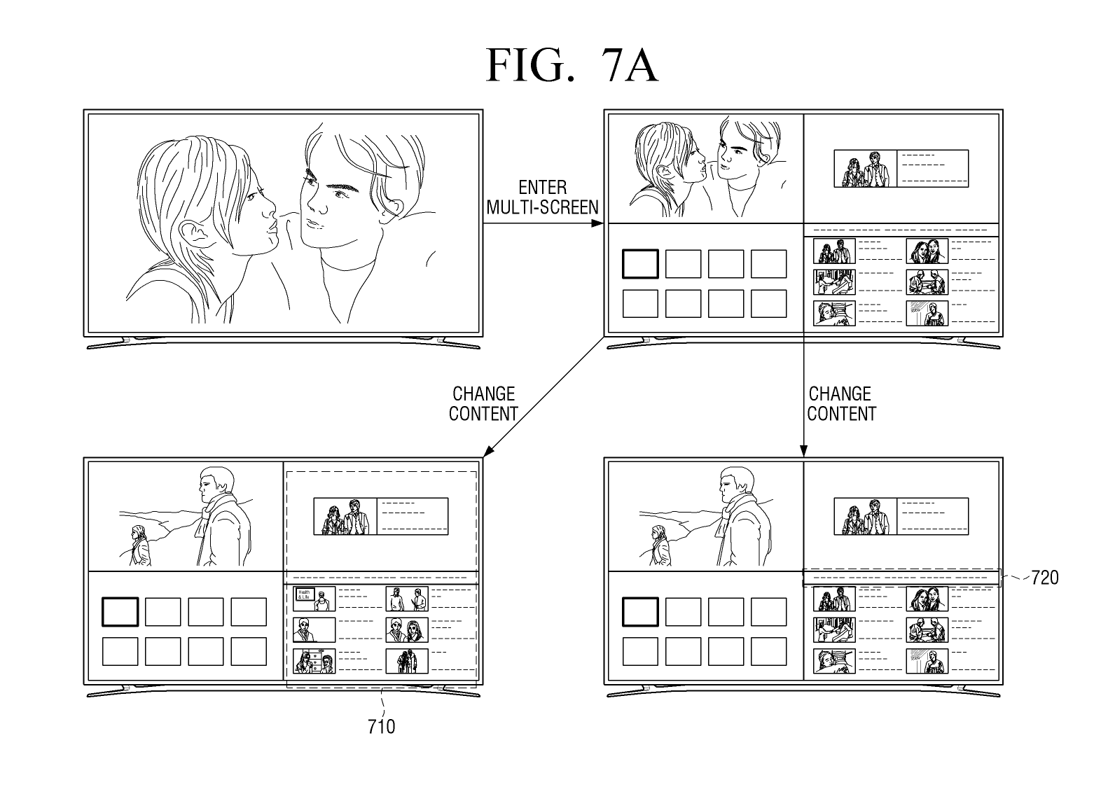

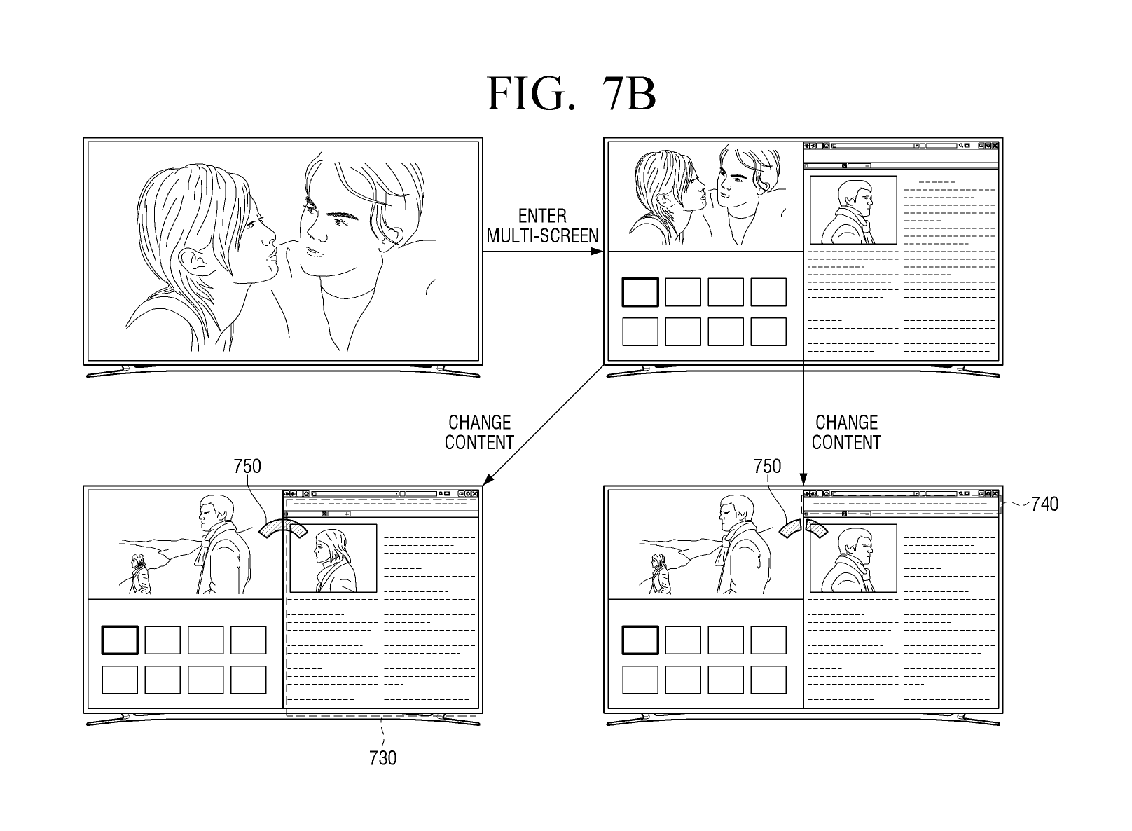

FIGS. 7A and 7B are diagrams illustrating a content refresh function according to one or more exemplary embodiments.

As shown in FIG. 7A, during watching of content, a current mode may enter a multi-screen mode according to a preset event to provide associated keyword information and associated content information. In FIG. 7A, it is assumed that a video content domain is set by default.

In this case, in response to currently watched content being changed (e.g., according to a change in channel, a change in scene, a change of show, a change to advertisements, etc.), different UI images may be provided according to whether the content refresh function is on or off.

In detail, when the content refresh function is on, a video content search result 710 retrieved according to an associated keyword as well as the associated keyword may be updated according to the changed content, as shown in a bottom left portion of FIG. 7A. In detail, a search may be automatically performed according to one of displayed keywords and the video content search result may be automatically updated and provided.

On the other hand, when the content refresh function is off, only an associated keyword 720 may be updated according to the changed content and a video content search result according to the keyword may not be updated and may be maintained, as shown in a bottom right portion of FIG. 7A. That is, a search result according to a keyword may be maintained as a video content search result of previously watched content. In this case, in response to the updated keyword being selected by a user, the video content search result retrieved according to the selected keyword may be provided.

In FIG. 7B, it is assumed that a web browser domain is set as default. In this case, similarly, in response to currently watched content being changed, different UI images may be provided according to whether the content refresh function is on or off.

In detail, when the content refresh function is on, a web browser search result 730 retrieved according to an associated keyword as well as the associated keyword may be updated according to the changed content, as shown in a bottom left portion of FIG. 7B.

On the other hand, when the content refresh function is off, only an associated keyword 740 may be updated according to the changed content and a web browser search result according to the keyword may not be updated and may be provided.

As illustrated in FIG. 7B, a GUI 750 for setting an on/off state of the content refresh function may be provided on a screen. In this case, a user may select the corresponding GUI 750 to easily set the on/off state of the content refresh function. In addition, the corresponding GUI 750 may be displayed in different forms according to an on/off state in such a way that the user checks an on/off state of the content refresh function.

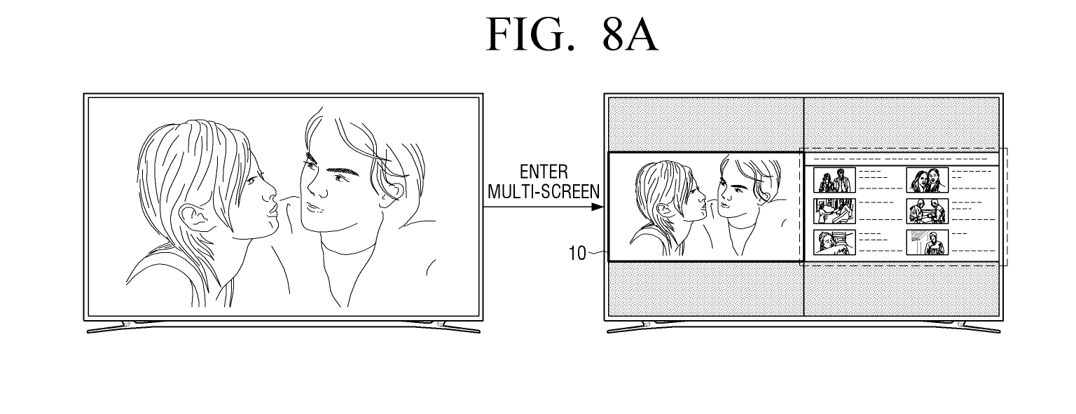

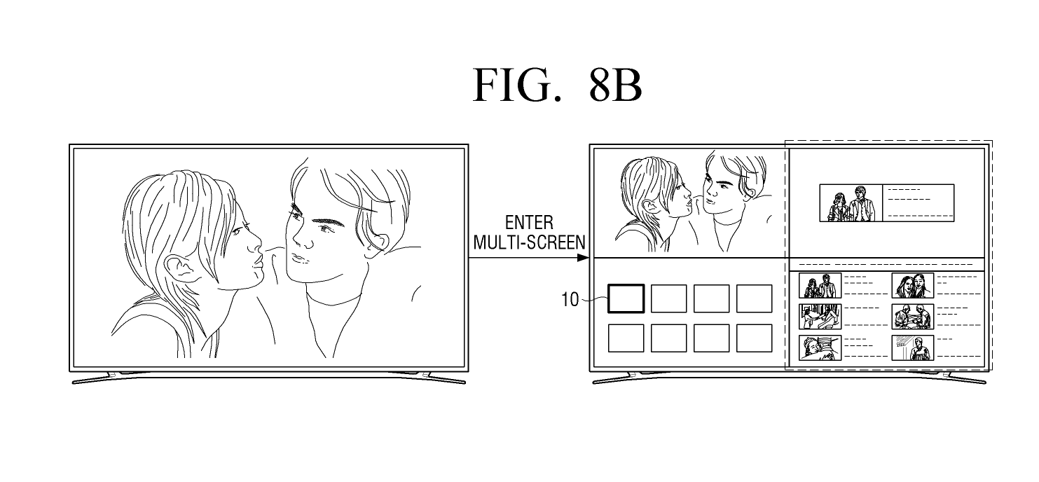

FIGS. 8A and 8B are diagrams illustrating a method for providing a multi-screen mode according to another exemplary embodiment.

As shown in FIGS. 8A and 8B, the multi-screen mode may be provided in various forms according to a resolution of a display.

For example, in the case of a full high definition (FHD) display, a multi-screen mode of including two screens may be provided, as shown in FIG. 8A, and in the case of an ultra high definition (UHD) display, a multi-screen mode of including three screens or more may be provided, as shown in FIG. 8B, although it is understood that one or more other exemplary embodiments are not limited thereto.

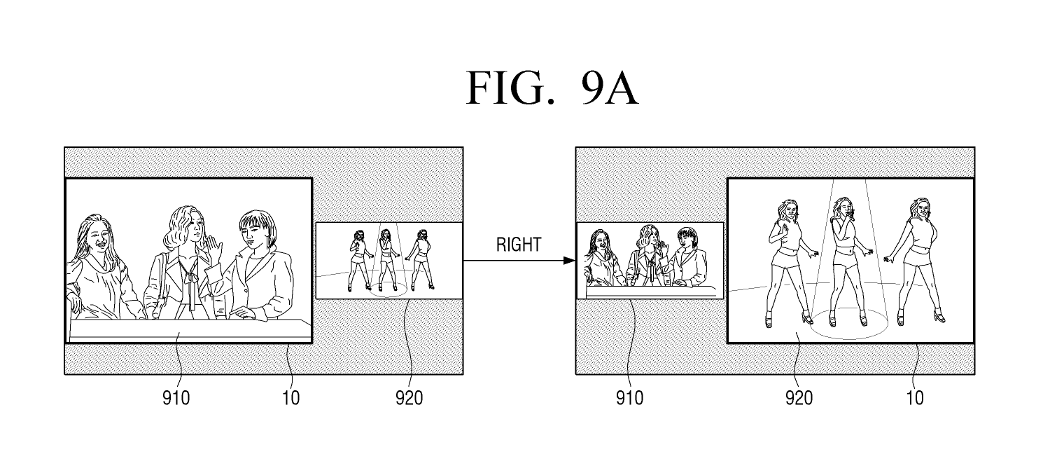

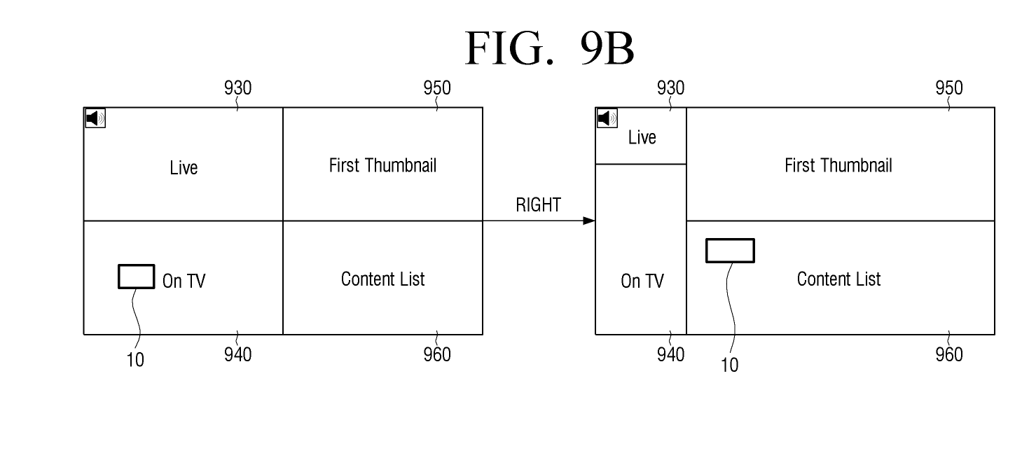

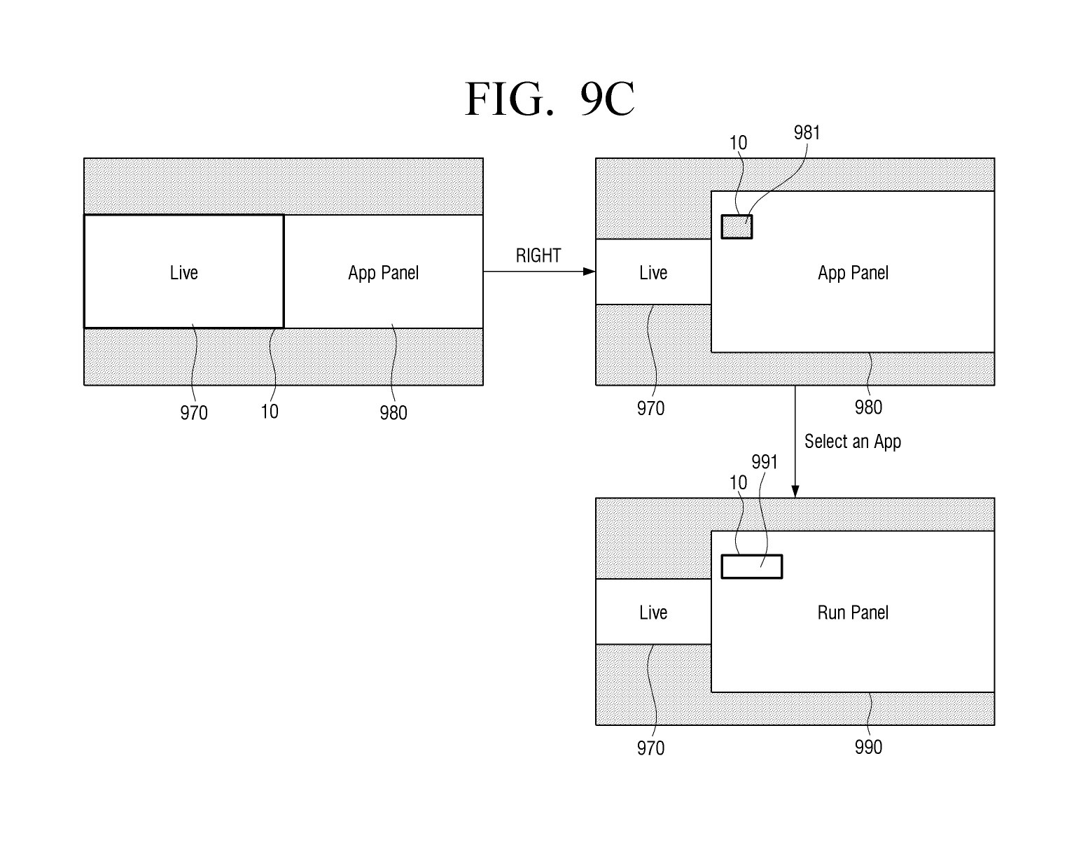

FIGS. 9A to 9C are diagrams illustrating a method of adjusting a screen size in a multi-screen mode according to another exemplary embodiment.

FIG. 9A is a diagram illustrating a method of adjusting a screen size in a multi-screen mode including two screens. As shown in FIG. 9A, a screen 910 including the selection GUI 10 positioned therein may be enlarged in size and displayed and the other screen 920 may be relatively reduced in size and may be displayed. In this case, the screen size may be enlarged or reduced at a preset ratio, for example, a ratio for maintaining a ratio between horizontal and vertical lengths of the screen.

FIG. 9B is a diagram illustrating a method of adjusting a screen size in a multi-screen mode including three screens or more. As shown in FIG. 9B, a screen 960 including an item including the selection GUI 10 positioned therein may be enlarged in size and displayed, and the other screens 930, 940, and 950 may be relatively changed in size and may be displayed.

In detail, as the screen 960 containing an item including the selection GUI 10 positioned therein is enlarged in size, when the other screens are changed in size, the screen 930 for providing the currently watched image may be reduced and the other screens 940 and 950 may be correspondingly changed in size while maintaining a preset ratio.

Referring to FIG. 9C, the enlarged screen size may be maintained until the selection GUI 10 is restored to a previous position.

As shown in FIG. 9C, the selection GUI 10 positioned in one screen 970 may be moved onto an item 981 contained in another screen 980 according to a movement command in a multi-screen mode. In this case, the screen 980 containing the item 981 including the selection GUI 10 positioned therein may be enlarged in size and the other screen 970 may be relatively reduced and may be displayed.

Then, as shown in a top right portion of FIG. 9C, in response to the item 981 including the selection GUI 10 positioned therein being selected, an image 990 corresponding to the corresponding item 981 may be provided, as shown in a bottom right portion of FIG. 9C, and in this case, a screen size may be maintained to be enlarged. In this case, the selection GUI 10 may be positioned on an item 991 contained in an executed image 990.

However, in response to the selection GUI 10 being restored to a previous position, that is, in response to the selection GUI 10 being moved to an image shown in a top left portion from a top right portion, a screen size may be restored to an original state.

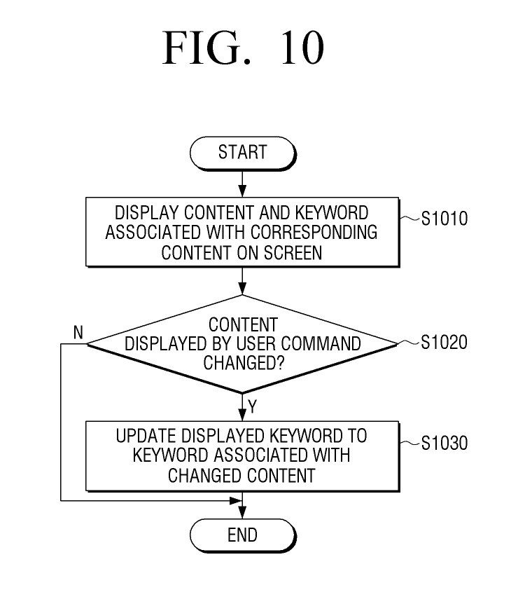

FIG. 10 is a flowchart illustrating a method of controlling a display apparatus according to an exemplary embodiment.

According to the method of controlling the display apparatus shown in FIG. 10, content and a keyword associated with the corresponding content may be displayed on a screen (operation S1010).

Then, in response to displayed content being changed according to a user command (Y of operation S1020), the displayed keyword is updated to a keyword associated with the changed content (operation S1030).

In this case, in operation S1010 of displaying a keyword, associated content information retrieved according to an associated keyword in a preset content search domain selected according to a preset event may be displayed.

Here, the content search domain may include at least one of a video content domain, a web browser domain, and an application domain.

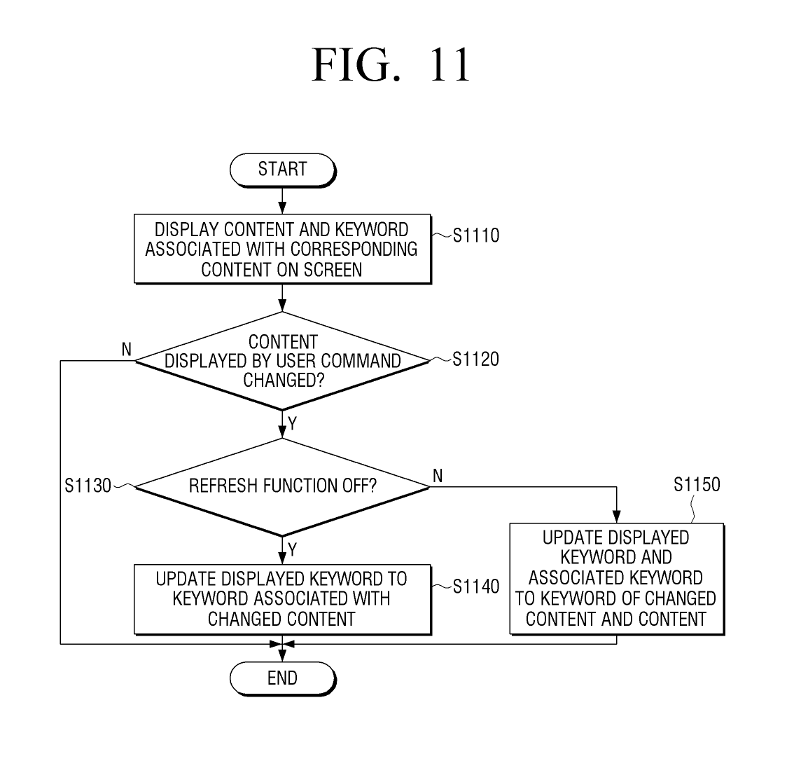

FIG. 11 is a flowchart illustrating a method of controlling a display apparatus according to another exemplary embodiment.

According to the method of controlling the display apparatus shown in FIG. 11, content and a keyword associated with the corresponding content may be displayed on a screen (operation S1110).

Then, in response to displayed content being changed according to a user command (Y of operation S 1120), whether a content refresh function is on or off is determined (operation S1130).

As a result of operation S1130, when the content refresh function is off (Y of operation S1130), displayed associated content information is maintained and only a displayed keyword (from among the keyword and the content information) is updated to a keyword associated with the changed content (operation S1140).

As a result of operation S1130, when the content refresh function is on (N of operation S1130), the displayed keyword is updated to a keyword associated with the changed content, and the displayed associated content information is updated to associated content information retrieved according to the updated keyword (operation S1150).

In this case, a GUI for selection of an on/off state of the content refresh function may be provided.

Furthermore, in operation S1110 of displaying a keyword, associated content information retrieved according to an associated keyword in a preset content search domain selected according to a preset event may be displayed.

Here, the content search domain may include at least one of a video content domain, a web browser domain, and an application domain.

In operation S1110 of displaying the keyword, content may be displayed on one of multi-screens and an associated keyword and associated content information may be displayed on another one of the multi-screens.

In addition, in operation S1110 of displaying the keyword, a selection GUI for selection of one of the multi-screen may be displayed. In this case, the controlling method may further include enlarging and displaying a screen region focused by a selection GUI and relatively reducing and displaying one or more remaining screen regions when a screen focused by the selection GUI is changed according to a user command.

The controlling method may further include focusing at least one item contained in the multi-screen by the selection GUI according to a user command, enlarging and displaying a screen region to which the item focused by the selection GUI belongs, and relatively reducing and displaying the remaining screen region.

In addition, the controlling method may further include executing content corresponding to an item while maintaining an enlarged screen size when the item focused by the selection GUI is selected.

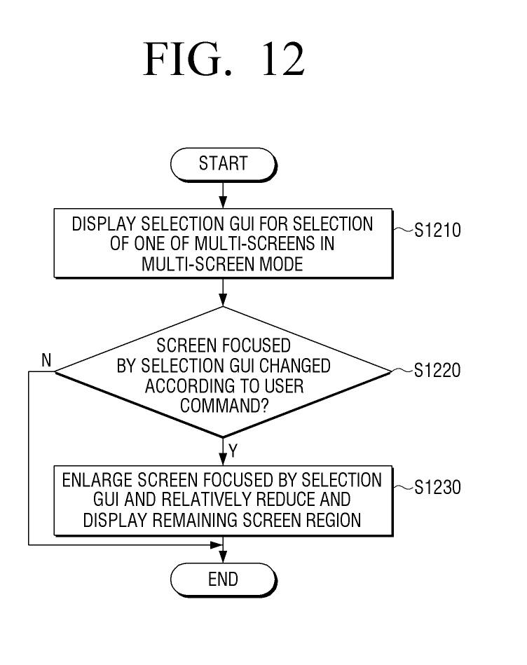

FIG. 12 is a flowchart illustrating a method of controlling a display apparatus according to another exemplary embodiment.

According to the method of controlling the display apparatus shown in FIG. 12, a selection GUI for selection of one of multi-screens is displayed in a multi-screen mode (operation S1210).

Then, in response to a screen focused by the selection GUI being changed according to a user command (Y of operation S1220), a screen region focused by the selection GUI may be increased and one or more remaining screen regions may be relatively reduced and may be displayed (operation S1230).

In this case, in operation S1230, the selection GUI may focus at least one item contained in multi-screens according to a user command, a screen region to which the item focused by the selection GUI belongs may be enlarged and displayed, and one or more remaining screen regions may be relatively reduced and displayed.

The controlling method may further include displaying an execution image of content corresponding to an item while maintaining an enlarged screen size when the item focused by the GUI is selected.

As described above, according to the aforementioned exemplary embodiments, associated information of currently watched content may be effectively provided through a multi-screen mode, thereby improving user convenience. In addition, a screen in which a user is interested may be enlarged in size and provided in a multi-screen mode, thereby improving user convenience.

According to an exemplary embodiment, an associated content providing service may be provided in the form of an application as software that is directly used by a user on an OS, and the application may be provided in the form of an icon interface on a screen of the display apparatus 100. However, it is understood that one or more other exemplary embodiments are not limited thereto, and when a corresponding service is subscribed, the associated content providing service may be provided in the form of a menu through the corresponding service.

Furthermore, while one or more exemplary embodiments are described above with reference to a display apparatus, it is understood that one or more other exemplary embodiments are not limited thereto, and may be applied to an image processing apparatus that processes images (e.g., processes and configures a multi-screen) and includes an output unit (e.g., outputter or output device) to output the images to an external display apparatus. Examples of such image processing apparatuses include a set-top box, an audio/video receiver, a media streaming device, a media server, etc.

A method of controlling the display apparatus according to one or more exemplary embodiments may be configured as a program executable by a computer or at least one processor and provided to each device so as to be executed by a processor while being stored in various non-transitory computer readable media.

For example, provided may be a non-transitory computer readable medium for storing a program for updating a displayed keyword to a keyword associated with changed content when content and the keyword associated with the content are displayed on a screen according to a preset event and the displayed content is changed according to a user command

The non-transitory computer readable media refers to a medium that semipermanently stores data and is readable by a device instead of a medium that stores data for a short time period, such as a register, a cache, a memory, etc. In detail, the aforementioned programs may be stored and provided in the non-transitory computer readable media such as CD, DVD, hard disc, blue ray disc, USB, a memory card, ROM, etc.

The foregoing exemplary embodiments and advantages are merely exemplary and are not to be construed as limiting the present inventive concept. Also, the description of exemplary embodiments is intended to be illustrative, and not to limit the scope of the claims, and many alternatives, modifications, and variations will be apparent to those skilled in the art.

What is claimed is:

1. A display apparatus comprising:
a display configured to display content on a screen;
a user interface configured to receive a user command; and
a processor configured to control the display to display a keyword associated with the displayed content and to update, in response to the displayed content being changed according to the received user command, the displayed keyword to an updated keyword associated with changed content.

2. The display apparatus as claimed in claim 1, wherein the processor is further configured to control the display to display associated content information obtained according to the displayed keyword.

3. The display apparatus as claimed in claim 2, wherein:
the processor is further configured to, when a content refresh function is off, control the display to maintain the displayed associated content information and to update the displayed keyword to the updated keyword associated with the changed content; and
the processor is further configured to, when the content refresh function is on, control the display to update the displayed keyword to the updated keyword associated with the changed content and to update the displayed associated content information to updated associated content information obtained according to the updated keyword.

4. The display apparatus as claimed in claim 3, wherein the processor is further configured to control the display to display a graphic user interface (GUI) for selection of an on/off state of the content refresh function.

5. The display apparatus as claimed in claim 2, wherein the processor is further configured to control the display to display the associated content information obtained according to the displayed keyword in a preset content search domain selected according to a preset event.

6. The display apparatus as claimed in claim 5, wherein the content search domain is selected from among at least one of a video content domain, a web browser domain, and an application domain.

7. The display apparatus as claimed in claim 2, wherein the processor is further configured to control the display to display the content on a screen from among multi-screens simultaneously presented on the display, and to display the associated keyword and the associated content information on at least one other screen among the multi-screens.

8. The display apparatus as claimed in claim 2, wherein:
the processor is further configured to control the display to simultaneously present multi-screens on the display;
the processor is further configured to control the display to display a selection GUI for selection of one of the multi-screens; and
the processor is further configured to control the display to enlarge a screen, among the multi-screens, focused by the selection GUI and to relatively reduce and display one or more remaining screens, among the multi-screens, when the selection GUI is focused on the screen according to a user command.

9. The display apparatus as claimed in claim 8, wherein the processor is further configured to control the display to focus at least one item contained in the multi-screens by the selection GUI according to the received user command, to enlarge the screen to which the at least one item focused by the selection GUI belongs, and to relatively reduce and display the one or more remaining screens.

10. The display apparatus as claimed in claim 9, wherein, in response to the at least one item focused by the selection GUI being selected, the processor is further configured to control the display to display a content executing image corresponding to the selected item while maintaining an enlarged screen size.

11. A method of controlling a display apparatus, the method comprising:
displaying content and a keyword associated with the content according to a preset event; and
in response to the displayed content being changed according to a user command, updating the displayed keyword to an updated keyword associated with the changed content.

12. The method as claimed in claim 11, wherein the displaying the keyword comprises displaying associated content information obtained according to the displayed keyword.

13. The method as claimed in claim 12, wherein the updating comprises:
when a content refresh function is off, maintaining the displayed associated content information and updating the displayed keyword to the updated keyword associated with the changed content; and
when the content refresh function is on, updating the displayed keyword to the updated keyword associated with the changed content and updating the displayed associated content information to updated associated content information obtained according to the updated keyword.

14. An image processing apparatus comprising:
a processor configured to control to:
output, for display, content;
output, for display, a keyword associated with the output content; and
update, in response to the output content being changed, the output keyword to an updated keyword associated with changed content.

15. The image processing apparatus as claimed in claim 14, wherein the processor is further configured to control to output, for display, associated content information obtained according to the output keyword.

16. The image processing apparatus as claimed in claim 15, wherein the processor is further configured to control to output, for display, the content on a screen from among multi-screens simultaneously output, and to output, for display, the associated keyword and the associated content information on at least one other screen among the multi-screens.

17. The image processing apparatus as claimed in claim 15, wherein the processor is further configured to control to:
simultaneously output, for display, multi-screens;
output, for display, a selection GUI for selection of one of the multi-screens; and
enlarge a screen, among the multi-screens, focused by the selection GUI and to relatively reduce and display one or more remaining screens, among the multi-screens, when the selection GUI is focused on the screen according to a user command.

18. The image processing apparatus as claimed in claim 17, wherein the processor is further configured to control to focus at least one item contained in the multi-screens by the selection GUI according to a user command, to enlarge the screen to which the at least one item focused by the selection GUI belongs, and to relatively reduce and output, for display, the one or more remaining screens.

19. A non-transitory computer readable recording medium having recorded thereon a program executable by a computer for performing the method of claim 11.
